(19) United States
(12) Patent Application Publication
(10) Pub. No.: US 2025/0304076 A1
(43) Pub. Date: Oct. 2, 2025

(54) DETERMINATION DEVICE, DETERMINATION METHOD, AND STORAGE MEDIUM

(71) Applicant: HONDA MOTOR CO., LTD., Tokyo (JP)

(72) Inventors: Takahiro Shimizu, Tokyo (JP); Sho Tamura, Tokyo (JP)

(21) Appl. No.: 19/059,608

(22) Filed: Feb. 21, 2025

(30) Foreign Application Priority Data
Mar. 28, 2024 (JP) 2024-054609

(51) Int. Cl. B60W 40/06

(52) U.S. Cl. CPC B60W 40/06; B60W 2420/40; B60W 2552/20; B60W 2556/35

(57) ABSTRACT

A determination device of an embodiment includes a first recognizer configured to recognize a surrounding situation including a first marking line for defining a movement path along which a mobile object is moving from an output of a detection device that detects a surrounding situation of the mobile object, a second recognizer configured to recognize a second marking line for defining a movement path around the mobile object from map information based on positional information of the mobile object, and a determiner configured to determine whether the first marking line and the second marking line deviate from each other, in which the map information includes height information and curve degree information of the movement path, and the determiner is configured to prevent determination that the first marking line and the second marking line deviate from each other when the height information and the curve degree information satisfy a prescribed condition.

### CROSS-REFERENCE TO RELATED APPLICATION

Priority is claimed on Japanese Patent Application No. 2024-054609, filed Mar. 28, 2024, the content of which is incorporated herein by reference.

### BACKGROUND

### Field of the Invention

The present invention relates to a determination device, a determination method, and a storage medium.

### Description of Related Art

In recent years, efforts have been actively made to provide access to a sustainable transportation system with special attention to people in vulnerable situations among traffic participants. To implement this, research and development for further improving the safety or convenience of traffic through research and development regarding an automated driving technique has been focused on. In this context, in the related art, a technique that selects any of a plurality of special measurement methods of measuring a curvature of a road in front on the basis of the accuracy of slope information or controls vehicle steering on the basis of a curvature of a traveling lane at a host vehicle position specified by a road curvature specifier and a lateral position of a host vehicle determined by a lateral position determiner is known (for example, Japanese Unexamined Patent Application, First Publication No. 2017-116450 and Japanese Patent No. 6415629).

### SUMMARY

Incidentally, in the automated driving technique of the related art, it is not considered that the appearance of a marking line changes due to a slope of a road, and there is a problem in that determination on a deviation between a marking line recognized from a camera or the like and a marking line acquired from map information may not be appropriately performed according to a situation of a road.

To solve the above-described problem, an object of the present application is to provide a determination device, a determination method, and a storage medium capable of more appropriately performing deviation determination of marking lines according to a situation of a movement path. The present application, in turn, contributes to development of a sustainable transportation system.

A determination device, a determination method, and a storage medium according to the invention employ the following configurations.

(1) A determination device according to an aspect of the invention includes a first recognizer configured to recognize a surrounding situation including a first marking line for defining a movement path along which a mobile object is moving, on the basis of an output of a detection device that detects a surrounding situation of the mobile object, a second recognizer configured to recognize a second marking line for defining a movement path around the mobile object from map information on the basis of positional information of the mobile object, and a determiner configured to determine whether the first marking line and the second marking line deviate from each other, in which the map information includes height information and curve degree information of the movement path, and the determiner is configured to prevent determination that the first marking line and the second marking line deviate from each other when the height information and the curve degree information satisfy a prescribed condition.

(2) In the aspect of (1) described above, the determiner is configured to predict that the first marking line recognized by the first recognizer deviates to one side or the other side in a movement path width direction when determination is made that the prescribed condition is satisfied compared to when the prescribed condition is not satisfied, and prevent the determination that the first marking line and the second marking line deviate from each other when a predicted deviation direction and a direction of the first marking line match each other.

(3) In the aspect of (2) described above, the height information is height information at a center of the movement path.

(4) In the aspect of (2) described above, the determiner is configured to perform determination using the prescribed condition in each of a marking line on an outside of a turn and a marking line on an inside of a turn of the movement path.

(5) In the aspect of (2) described above, the determiner is configured to prevent the determination that the first marking line and the second marking line deviate from each other when a longitudinal slope influence degree in a pitch direction of the mobile object based on the height information and a lateral slope influence degree in a roll direction of the mobile object based on the curve degree information satisfy the prescribed condition.

(6) In the aspect of (5) described above, the prescribed condition includes a case that the lateral slope influence degree is greater than a first threshold greater than 0.

(7) In the aspect of (5) described above, the prescribed condition includes a case where the lateral slope influence degree is less than a second threshold smaller than 0.

(8) In the aspect of (5) described above, the prescribed condition includes a case where a value obtained by adding the longitudinal slope influence degree and the lateral slope influence degree is greater than a third threshold.

(9) In the aspect of (5) described above, the prescribed condition includes a case where a value obtained by adding the longitudinal slope influence degree and the lateral slope influence degree is less than a fourth threshold.

(10) In the aspect of (5) described above, the prescribed condition includes a case where the longitudinal slope influence degree is greater than a fifth threshold greater than 0.

(11) In the aspect of (5) described above, the prescribed condition includes a case where the longitudinal slope influence degree is less than a sixth threshold smaller than 0.

(12) In the aspect of (5) described above, the prescribed condition includes a case where the lateral slope influence degree is equal to or less than a first threshold, the longitudinal slope influence degree is equal to or less than a fifth threshold, and a value obtained by adding the longitudinal slope influence degree and the lateral slope influence degree is greater than a third threshold.

(13) In the aspect of (5) described above, the prescribed condition includes a case where the lateral slope influence degree is equal to or greater than a second threshold, the longitudinal slope influence degree is equal to or greater than a sixth threshold, and a value obtained by adding the longitudinal slope influence degree and the lateral slope influence degree is less than a fourth threshold.

(14) In the aspect of (5) described above, the prescribed condition is a case where the height information and the curve degree information are greater than a prescribed value, and the determiner is configured to predict that the first marking line is likely to deviate in both directions of one side and the other side in the movement path width direction when the prescribed condition is satisfied.

(15) In the aspect of (5) described above, the prescribed condition is a case where the lateral slope influence degree is greater than a first threshold greater than 0 and the longitudinal slope influence degree is less than a sixth threshold smaller than 0, and, and the determiner is configured to predict that the first marking line is likely to deviate in both directions of one side and the other side in the movement path width direction when the prescribed condition is satisfied.

(16) In the aspect of (5) described above, the prescribed condition is a case where the lateral slope influence degree is less than a second threshold smaller than 0 and the longitudinal slope influence degree is greater than a fifth threshold greater than 0, and, and the determiner is configured to predict that the first marking line is likely to deviate in both directions of one side and the other side in the movement path width direction when the prescribed condition is satisfied.

(17) A determination method according to another aspect of the invention includes, by a computer, recognizing a surrounding situation including a first marking line for defining a movement path along which a mobile object is moving, on the basis of an output of a detection device that detects a surrounding situation of the mobile object, recognizing a second marking line for defining a movement path around the mobile object from map information on the basis of positional information of the mobile object, and determining whether the first marking line and the second marking line deviate from each other, in which the map information includes height information and curve degree information of the movement path, and when the height information and the curve degree information satisfy a prescribed condition, determination that the first marking line and the second marking line deviate from each other is prevented.

(18) A computer-readable non-transitory storage medium according to still another aspect of the present invention stores a program for causing a computer to recognize a surrounding situation including a first marking line for defining a movement path along which a mobile object is moving, on the basis of an output of a detection device that detects a surrounding situation of the mobile object, recognize a second marking line for defining a movement path around the mobile object from map information on the basis of positional information of the mobile object, and determine whether the first marking line and the second marking line deviate from each other, in which the map information includes height information and curve degree information of the movement path, and when the height information and the curve degree information satisfy a prescribed condition, determination that the first marking line and the second marking line deviate from each other is prevented.

According to the aspects of (1) to (18) described above, it is possible to more appropriately perform deviation determination of marking lines according to a situation of a movement path.

### BRIEF DESCRIPTION OF THE DRAWINGS

FIG. 1 is a configuration diagram of a vehicle system including a determination device according to an embodiment.

FIG. 2 is a functional configuration diagram of a first controller and a second controller.

FIG. 3 is a diagram illustrating driving control of a host vehicle M in a first scene.

FIG. 4 is a diagram illustrating traveling on a road having a slope in a second scene.

FIG. 5 is a diagram illustrating an influence on appearance of a camera marking line due to a lateral slope near the host vehicle.

FIG. 6 is a diagram illustrating an influence on appearance of a camera marking line due to a lateral slope at a position away from the host vehicle.

FIG. 7 is a diagram illustrating an influence on appearance of a camera marking line due to a longitudinal slope of the host vehicle.

FIG. 8 is a diagram illustrating prescribed conditions for a longitudinal slope influence degree and a lateral slope influence degree in the embodiment.

FIG. 9 is a diagram illustrating determination on whether a camera marking line is under a slope influence.

FIG. 10 is a diagram illustrating shapes of a camera marking line and a map marking line as viewed from a host vehicle that is traveling on a curved road.

FIG. 11 is a diagram showing an example of marking line selection by a selector.

FIG. 12 is a flowchart illustrating an example of a flow of driving control processing in the embodiment.

FIG. 13 is a flowchart illustrating an example of deviation determination processing.

FIG. 14 is a flowchart illustrating an example of selection processing.

### DESCRIPTION OF EMBODIMENTS

Hereinafter, an embodiment of a determination device, a determination method, and a storage medium of the present invention will be described with reference to the drawings. In the following description, an embodiment where it is assumed that a vehicle is used as an example of a mobile object, and a determination device is applied to an automated driving vehicle will be described. Automated driving means that one or both of, for example, steering and a speed of a vehicle is automatically controlled to execute driving control. The driving control may include, for example, various kinds of driving control such as automated lane change (ALC), lane keeping assistance system (LKAS), adaptive cruise control system (ACC), traffic jam pilot (TJP), and collision mitigation brake system (CMBS). In an automated driving vehicle, driving control (so-called manual driving) by a manual operation of a user (for example, an occupant) of the vehicle may be executed. The mobile object may include, for example, a vessel capable of moving on the ground such as a hovercraft, a flying object capable of traveling on a road, and a standing vehicle having a power unit, in addition to the vehicle.

### Overall Configuration

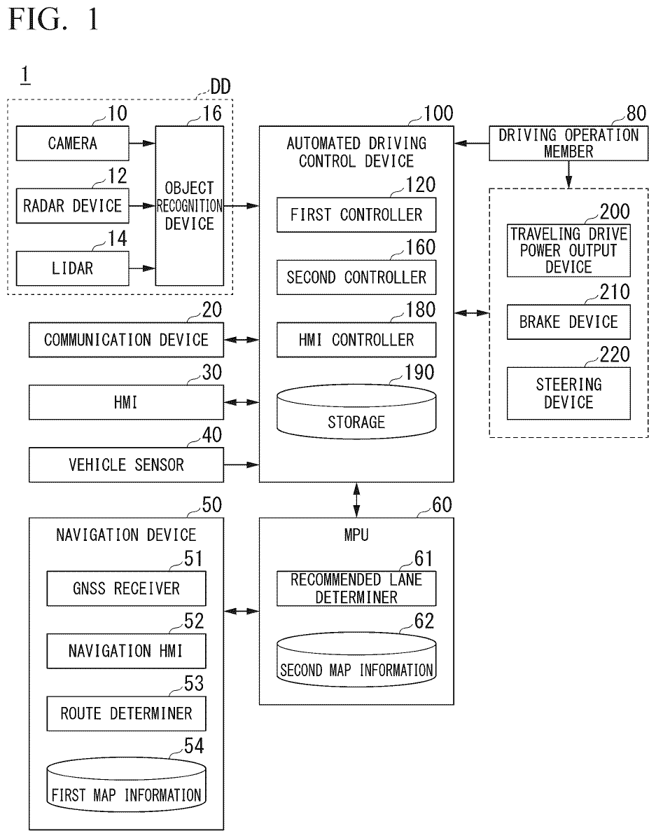

FIG. 1 is a configuration diagram of a vehicle system 1 including a determination device according to the embodiment. A vehicle (hereinafter, referred to as a host vehicle M) in which the vehicle system 1 is mounted is, for example, a two-wheeled, three-wheeled, or four-wheeled vehicle or a micro-mobility, and a power source is an internal combustion engine such as a diesel engine or a gasoline engine, an electric motor, and a combination thereof. The electric motor operates using electric power generated by a generator coupled to the internal combustion engine or electric power discharged from a battery (storage battery) such as a secondary battery or a fuel cell.

The vehicle system 1 includes, for example, a camera 10, a radar device 12, a light detection and ranging (LIDAR) 14, an object recognition device 16, a communication device 20, a human machine interface (HMI) 30, a vehicle sensor 40, a navigation device 50, a map positioning unit (MPU) 60, a driving operation member 80, an automated driving control device 100, a traveling drive power output device 200, a brake device 210, and a steering device 220. These devices and apparatuses are connected to each other by a multiplex communication line such as a controller area network (CAN), a serial communication line, or a wireless communication network. The configuration shown in FIG. 1 is merely an example, and a part of the configuration may be omitted or another configuration may be added. A combination of the camera 10, the radar device 12, the LIDAR 14, and the object recognition device 16 is an example of a “detection device DD”. The HMI 30 is an example of an “output device”. The automated driving control device 100 is an example of a “determination device”.

The camera 10 is, for example, a digital camera using a solid-state imaging element such as a charge coupled device (CCD) or a complementary metal oxide semiconductor (CMOS). The camera 10 is attached at any place on the host vehicle M in which the vehicle system 1 is mounted. In imaging an area in front, the camera 10 is attached to an upper portion of a front windshield, a back surface of a rear-view mirror, a front part of a vehicle body, or the like. In imaging an area behind, the camera 10 is attached to an upper portion of a rear windshield, a back door, or the like. In imaging an area to the side, the camera 10 is attached to a door mirror or the like. The camera periodically and repeatedly images the vicinity of the host vehicle M, for example. The camera 10 may be a stereo camera.

The radar device 12 radiates radio waves such as millimeter waves to the vicinity of the host vehicle M and detects radio waves (reflected waves) reflected by an object in the vicinity of the host vehicle M to detect at least a position of (a distance to and a direction of) the object. The radar device 12 is attached at any place on the host vehicle M. The radar device 12 may detect a position and a speed of an object by a frequency modulated continuous wave (FM-CW) method.

The LIDAR 14 emits light to the vicinity of the host vehicle M and measures scattered light. The LIDAR 14 detects a distance to a target on the basis of a time from light emission and light reception. The emitted light is, for example, pulsed laser light. The LIDAR 14 is attached at any place on the host vehicle M.

The object recognition device 16 executes sensor fusion processing on detection results of a part or all of the camera 10, the radar device 12, and the LIDAR 14 to recognize a position, a type, a speed, and the like of an object. The object recognition device 16 outputs a recognition result to the automated driving control device 100. The object recognition device 16 may output the detection results of the camera 10, the radar device 12, and the LIDAR 14 to the automated driving control device 100 without change. In this case, the object recognition device 16 may be omitted from the configuration of the vehicle system 1 (detection device DD).

The communication device 20 communicates with another vehicle in the vicinity of the host vehicle M, a terminal device of a user who uses the host vehicle M, or various server devices using, for example, a network such as cellular network, a Wi-Fi network, Bluetooth (Registered Trademark), dedicated short range communication (DSRC), a local area network (LAN), a wide area network (WAN), or the Internet.

The HMI 30 outputs various kinds of information to an occupant of the host vehicle M and receives an input operation by the occupant. The HMI 30 includes, for example, various display devices, a speaker, a buzzer, a touch panel, a switch, keys, and a microphone.

The vehicle sensor 40 includes a vehicle speed sensor that detects a speed of the host vehicle M, an acceleration sensor that detects an acceleration, a yaw rate sensor that detects a yaw rate (for example, a rotational angularly velocity around a vertical axis passing through the center of gravity of the host vehicle M), a direction sensor that detects a direction of the host vehicle M, and the like. The vehicle sensor 40 may be provided with a position sensor that detects a position of the host vehicle M. The position sensor is an example of a “position measurer”. The position sensor is, for example, a sensor that acquires positional information (longitude/latitude information) from a global positioning system (GPS) device. The position sensor may be a sensor that acquires positional information using a global navigation satellite system (GNSS) receiver 51 of the navigation device 50. The vehicle sensor 40 may derive a speed of the host vehicle M from a difference (that is, a distance) in positional information in a prescribed time of the position sensor. A result detected by the vehicle sensor 40 is output to the automated driving control device 100.

The navigation device 50 includes, for example, the GNSS receiver 51, a navigation HMI 52, and a route determiner 53. The navigation device 50 stores first map information 54 in a storage device such as a hard disk drive (HDD) or a flash memory. The GNSS receiver 51 specifies the position of the host vehicle M on the basis of signals from GNSS satellites. The position of the host vehicle M may be specified or completed by an inertial navigation system (INS) using an output of the vehicle sensor 40. The navigation HMI 52 includes a display device, a speaker, a touch panel, keys, and the like. The GNSS receiver 51 may be provided in the vehicle sensor 40. The navigation HMI 52 may be partially or entirely shared with the HMI 30 described above. The route determiner 53 determines a route (hereinafter, referred to as an on-map route), for example, from the position of the host vehicle M specified by the GNSS receiver 51 (or any input position) to a destination input by the occupant using the navigation HMI 52 with reference to the first map information 54. The first map information 54 is, for example, information in which a road shape is expressed by a link indicating a road (an example of a movement path) and nodes connected by the link. The first map information 54 may include point of interest (POI) information or the like. The on-map route is output to the MPU 60. The navigation device 50 may perform route guidance using the navigation HMI 52 on the basis of the on-map route. The navigation device 50 may transmit a current position and a destination to a navigation server via the communication device 20 and may acquire a route equivalent to the on-map route from the navigation server. The navigation device 50 outputs the determined on-map route to the MPU 60.

The MPU 60 includes, for example, a recommended lane determiner 61 and stores second map information 62 in a storage device such as an HDD or a flash memory. The recommended lane determiner 61 divides the on-map route provided from the navigation device 50 into a plurality of blocks (for example, divides the on-map route every 100 [m] in a vehicle moving direction), and determines a recommended lane for each block with reference to the second map information 62. The recommended lane determiner 61 performs determination which lane from the left the vehicle travels on. When a branch point is present on the on-map route, the recommended lane determiner 61 determines a recommended lane such that the host vehicle M can travel along a reasonable route for advancing to a branch destination.

The second map information 62 is map information with higher accuracy than the first map information 54. The second map information 62 includes, for example, the number of lanes (the number of movement paths), a type or a shape of road marking line (hereinafter, referred to as marking line), information on a center of a lane, information on a road boundary, or the like. The second map information 62 may include information on whether the road boundary is a boundary (physical boundary) including a structure over which the passage (also including crossing and contact) of the vehicle is impossible. The physical boundary is, for example, a guard rail, a curbstone, a median strip, or a fence. A case where the passage of the vehicle is impossible may include a case where there is so low a step to allow passage when vibration of the vehicle that cannot normally occur is allowed. The second map information 62 may include road shape information, traffic regulation information, address information (address or zip code), facility information, parking lot information, telephone number information, or the like. The road shape information is, for example, a width, height information, or a curve degree. Here, the height information is, for example, height information from a reference position (for example, a horizontal position) at the center of the road (movement path), may be a road elevation, or may be height difference information at each prescribed distance. The curve degree is, for example, an index value indicating the magnitude of a curvature of a road (may be replaced with the size of a radius of curvature: the same applies to the following), and the greater the curvature is, the greater the curve degree becomes. The curve degree may be a curvature value or a curvature change amount. In the following description, it is assumed that a slope (longitudinal slope) in a longitudinal direction of a road (movement path) or a slope (lateral slope) in a lateral direction of a road is not stored in the second map information 62. The second map information 62 may be updated at any time by the communication device 20 communicating with an external device. The first map information 54 and the second map information 62 may be provided integrally as map information. The map information may be stored in a storage 190.

The driving operation member 80 includes, for example, a steering wheel, an accelerator pedal, and a brake pedal. The driving operation member 80 may include a shift lever, a deformed steering wheel, a joystick, and other operation members. Each operation member of the driving operation member 80 is attached with, for example, an operation detector that detects an operation amount of an operation member by the occupant or the presence or absence of an operation. The operation detector detects, for example, a steering angle or steering torque of the steering wheel or a depression amount of the accelerator pedal or the brake pedal. Then, the operation detector outputs a detection result to one or both of the automated driving control device 100 and the traveling drive power output device 200, the brake device 210 and the steering device 220.

The automated driving control device 100 executes various kinds of driving control belonging to automated driving on the host vehicle M. The automated driving control device 100 includes, for example, a first controller 120, a second controller 160, an HMI controller 180, and a storage 190. Each of the first controller 120, the second controller 160, and the HMI controller 180 may be implemented by a hardware processor such as a central processing unit (CPU) executing a program (software). A part or all of these components may be implemented by hardware (circuit, including circuitry) such as a large scale integration (LSI), an application specific integrated circuit (ASIC), a field-programmable gate array (FPGA), a graphics processing unit (GPU), or a system on chip (SOC) or may be implemented by software and hardware in cooperation. The program may be stored in advance in a storage device (a storage device including a non-transitory storage medium) such as an HDD or a flash memory of the automated driving control device 100 or may be stored in a removable storage medium such as a DVD, a CD-ROM, or a memory card and may be installed on the storage device of the automated driving control device 100 when the storage medium (non-transitory storage medium) is loaded into a drive device.

The storage 190 may be implemented by various storage devices described above, an electrically erasable programmable read only memory (EEPROM), a read only memory (ROM), a random access memory (RAM), or the like. The storage 190 stores, for example, various kinds of information in the embodiment and programs. The storage 190 may store map information (for example, first map information 54 and second map information 62).

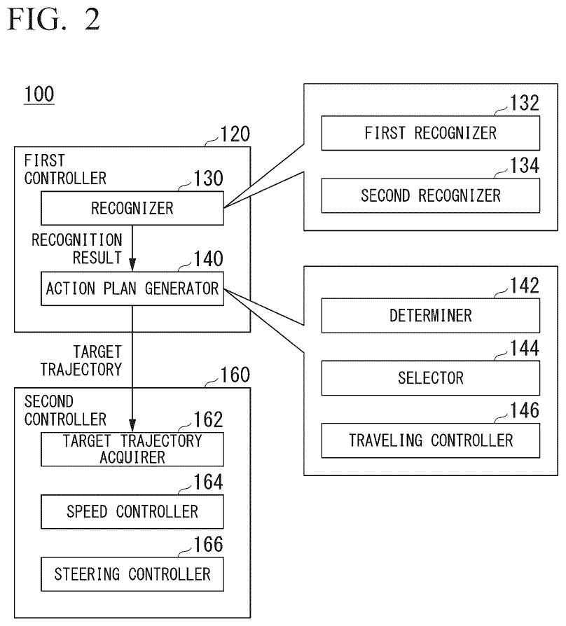

FIG. 2 is a functional configuration diagram of the first controller 120 and the second controller 160. The first controller 120 includes, for example, a recognizer 130 and an action plan generator 140. The first controller 120 simultaneously implements, for example, functions by artificial intelligence (AI) and functions using a model given in advance. For example, a function of “recognizing an intersection” may be implemented by simultaneously executing recognition of an intersection by deep learning or the like and recognition based on conditions given in advance (a signal, a road sign, and the like that can be used for pattern matching) and scoring both recognitions to comprehensively evaluate the recognitions. Accordingly, the reliability of automated driving is secured. The first controller 120 executes control regarding automated driving of the host vehicle M on the basis of, for example, an instruction from the MPU 60 or the HMI controller 180.

The recognizer 130 recognizes a surrounding situation of the host vehicle M on the basis of a recognition result (information input from at least the camera 10 among the camera 10, the radar device 12, and the LIDAR 14 via the object recognition device 16) of the detection device DD. For example, the recognizer 130 recognizes a state such as a position, a speed, or an acceleration of an object around the host vehicle M (within a prescribed distance). The object includes a traffic participant such as another vehicle, a pedestrian, or a bicycle, a physical boundary for defining a road (movement path), or the like. A position of an object is recognized as, for example, a position on absolute coordinates with a representative point (the center of gravity, a drive axis center, or the like) of the host vehicle M as an origin and is used for control. The position of the object may be represented by a representative point such as the center of gravity or a corner of the object or may be represented by a region. For example, when an object is a mobile object such as another vehicle, a “state” of an object may include an acceleration or a jerk of the mobile object or an “action state” of the mobile object (for example, whether another vehicle is changing a lane or is about to change a lane).

The recognizer 130 recognizes, for example, a temporary stop line, an obstacle, a red signal, a toll gate, and other road events, a sign (speed limit) marked on a road, and a road sign on which a speed limit is marked. The recognizer 130 includes, for example, a first recognizer 132 and a second recognizer 134. Details of these functions will be described below.

The action plan generator 140 generates an action plan that causes the host vehicle M to travel through automated driving on the basis of a recognition result of the recognizer 130, or the like. For example, the action plan generator 140 generates a target trajectory along which the host vehicle M basically travels on the recommended lane determined by the recommended lane determiner 61 and the host vehicle M will automatically travel (without depending on an operation of a driver) in the future such that the host vehicle M can cope with the surrounding situation of the host vehicle M, on the basis of a recognition result of the recognizer 130, a shape of a surrounding road based on a current position of the host vehicle acquired from the map information, or the like. The target trajectory includes, for example, a speed element. For example, the target trajectory is expressed by sequentially arranging points (trajectory points) that the host vehicle M will reach. The trajectory points are points that the host vehicle M will reach at each prescribed traveling distance (for example, about several [m] in a road distance, and separately, a target speed and a target acceleration at each prescribed sampling time (for example, about several tenths of a [sec]) are generated as a part of the target trajectory. The trajectory points may be positions that the host vehicle M will reach within a prescribed sampling time at each sampling time. In this case, information on the target speed or the target acceleration is expressed by an interval of the trajectory points.

The action plan generator 140 may set an event of automated driving in generating the target trajectory. Examples of the event include a constant-speed traveling event in which the host vehicle M is caused to travel on the same lane at a constant speed, a following traveling event in which the host vehicle M is caused to follow another vehicle present within a prescribed distance (for example, within 100 [m]) in front of the host vehicle M and closest to the host vehicle M, a land change event in which the host vehicle M is caused to change from a host lane to an adjacent lane, a branching event in which the host vehicle M is caused to branch to a lane on a destination side at a branch point of a road, a merging event in which the host vehicle M is caused to merge with a main lane at a merging point, and a takeover event for ending automated driving and performing switching to manual driving. Examples of the event may include an overtaking event in which the host vehicle M is first caused to change a lane to an adjacent lane, overtake a preceding vehicle in the adjacent lane, and change the lane to an original lane, and an avoidance event in which the host vehicle M is caused to perform at least one of braking and steering to avoid an obstacle present in front of the host vehicle M.

The action plan generator 140 may change an event already determined for a current section to another event or may set a new event for the current section, for example, according to the surrounding situation of the host vehicle M recognized during traveling of the host vehicle M. The action plan generator 140 may change the event already set for the current section to another event or may set a new event for the current section according to an operation of the occupant on the HMI 30. The action plan generator 140 generates a target trajectory according to the set event.

The action plan generator 140 includes, for example, a determiner 142, a selector 144, and a traveling controller 146. The first recognizer 132, the second recognizer 134, and the determiner 142 are an example of a “determination device”. The traveling controller 146 and the second controller 160 are an example of a “movement controller”. Details of these functions will be described below.

The second controller 160 controls the traveling drive power output device 200, the brake device 210, and the steering device 220 such that the host vehicle M passes through the target trajectory generated by the action plan generator 140 at a scheduled time.

The second controller 160 includes, for example, a target trajectory acquirer 162, a speed controller 164, and a steering controller 166. The target trajectory acquirer 162 acquires information on the target trajectory (trajectory points) generated by the action plan generator 140 and stores the acquired information in a memory (not shown).

The speed controller 164 controls the traveling drive power output device 200 or the brake device 210 on the basis of the speed element incidental to the target trajectory stored in the memory. The steering controller 166 controls the steering device 220 according to a curve state of the target trajectory stored in the memory. Processing of the speed controller 164 and the steering controller 166 is implemented by, for example, a combination of feedforward control and feedback control. As an example, the steering controller 166 executes a combination of feedforward control according to a curvature of a road in front of the host vehicle M and feedback control based on a deviation from the target trajectory.

Returning to FIG. 1, the HMI controller 180 notifies the occupant of prescribed information with the HMI 30. The prescribed information includes, for example, information related to traveling of the host vehicle M such as information regarding a state of the host vehicle M or information regarding driving control. Information regarding the state of the host vehicle M includes, for example, the speed of the host vehicle M, an engine rotation speed, and a shift position. Information regarding the driving control includes, for example, the presence or absence of execution of driving control by automated driving, information for inquiring whether to start automated driving, information regarding a driving control situation by automated driving, information regarding an automation level, and information for prompting the occupant to perform driving when switching from automated driving to manual driving occurs. The prescribed information may include information regarding the surrounding situation recognized by the detection device DD. The prescribed information may include information not related to traveling of the host vehicle M such as television programs or contents (for example, movie) stored in a storage medium such as a DVD. The prescribed information may include, for example, information regarding a current position or a destination in automated driving and residual amount of fuel of the host vehicle M. The HMI controller 180 may output information received by the HMI 30 to the communication device 20, the navigation device 50, the first controller 120, and the like.

The HMI controller 180 may cause the HMI 30 to output information on inquiry to the occupant, processing results of the first controller 120 and the second controller 160, or the like. The HMI controller 180 may transmit various kinds of information to be output by the HMI 30 to a terminal device that is used by the occupant of the host vehicle M, via the communication device 20.

The traveling drive power output device 200 outputs traveling drive power (torque) for the vehicle to travel to drive wheels. The traveling drive power output device 200 includes, for example, a combination of an internal combustion engine, an electric motor, a transmission, and the like, and an electronic control unit (ECU) that controls the internal combustion engine, the electric motor, the transmission, and the like. The ECU controls the above-described configuration according to information input from the second controller 160 or information input from the accelerator pedal of the driving operation member 80.

The brake device 210 includes, for example, a brake caliper, a cylinder that transmits a hydraulic pressure to the brake caliper, an electric motor that generates the hydraulic pressure in the cylinder, and a brake ECU. The brake ECU controls the electric motor according to information input from the second controller 160 or information input from the brake pedal of the driving operation member 80 such that a brake torque according to a braking operation is output to each wheel. The brake device 210 may include, as a backup, a mechanism that transmits the hydraulic pressure generated by an operation of the brake pedal to the cylinder via a master cylinder. The brake device 210 is not limited to the configuration described above, and may be an electronically controlled hydraulic brake device that controls an actuator according to information input from the second controller 160 to transmit the hydraulic pressure of the master cylinder to the cylinder.

The steering device 220 includes, for example, a steering ECU and an electric motor. The electric motor applies force to a rack-and-pinion mechanism to change a direction of turning wheels, for example. The steering ECU drives the electric motor according to information input from the second controller 160 or information input from the steering wheel of the driving operation member 80 and changes the direction of the turning wheels.

### Recognizer and Action Plan Generator

Next, details of the functions of the recognizer 130 (mainly, the first recognizer 132 and the second recognizer 134) and the action plan generator 140 (mainly, the determiner 142, the selector 144, and the traveling controller 146) will be described. Hereinafter, content of driving control of the host vehicle M (movement control of a mobile object) using the functions of the recognizer 130 and the action plan generator 140 will be divided into several scenes and described.

### First Scene

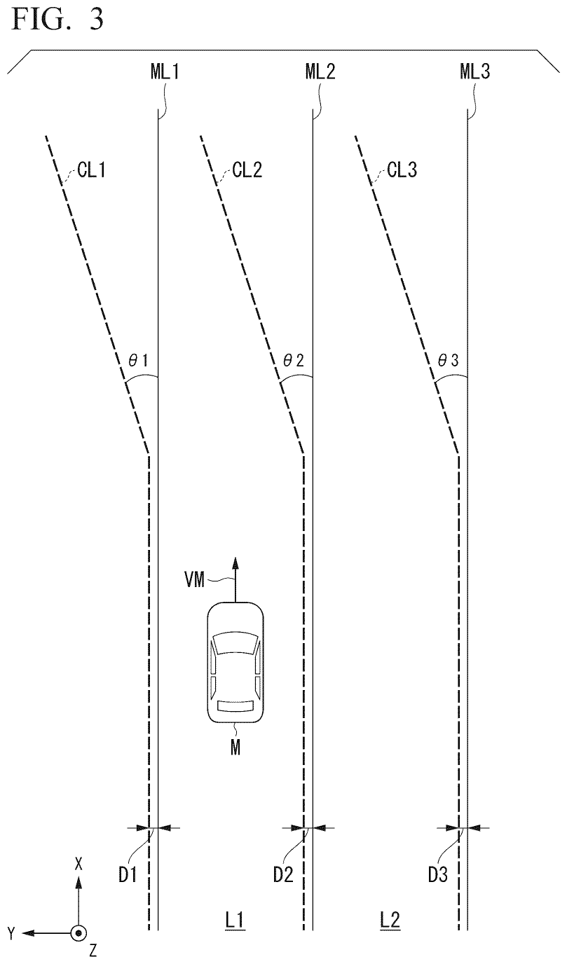

FIG. 3 is a diagram illustrating driving control of the host vehicle M in a first scene. The first scene shows driving control of the host vehicle M in a road situation in which there is no longitudinal slope (a slop in a longitudinal direction (a moving direction of the host vehicle M) of a road (movement path) and there is no lateral slope (a slope in a lateral direction of the road). In the example of FIG. 3, marking lines CL1 to CL3 recognized by the detection device DD and marking lines ML1 to ML3 obtained from the map information (for example, the second map information 62) on the basis of the positional information of the host vehicle M are shown. In the map information, a lane L1 is defined by the marking lines ML1 and ML2, and a lane L2 is defined by the marking lines ML2 and ML3. The lanes L1 and L2 are lanes on which vehicles can move in the same direction (in the drawing, an X-axis direction). In the example of FIG. 3, the marking lines CL1 to CL3 are an example of a “first marking line”, and the marking lines ML1 to ML3 are an example of a “second marking line”. Hereinafter, the marking lines CL1 to CL3 may be referred to as “camera marking lines CL1 to CL3”, and the marking lines ML1 to ML3 may be referred to as “map marking lines ML1 to ML3”. The camera marking lines CL1 to CL3 may be simply referred to as a camera marking line CL when there is no need for distinction therebetween, and the map marking lines ML1 to ML3 may be simply referred to as a “map marking line ML” when there is no need for distinction therebetween. In the first scene shown in FIG. 3, it is assumed that the host vehicle M is traveling (moving) on the lane L1 at a speed VM along an extension direction (the longitudinal direction, and in the drawing, the X axis) of the lane L1.

In the first scene, the first recognizer 132 recognizes the surrounding situation of the host vehicle M on the basis of an output of the detection device DD that detects the surrounding situation (external world) of the host vehicle M. For example, the first recognizer 132 recognizes the left and right camera marking lines CL1 and CL2 that define a traveling lane (lane L1) of the host vehicle M, on the basis of an image (hereinafter, referred to as a camera image) captured by the camera 10. The first recognizer 132 may recognize the camera marking line CL3 that defines an adjacent lane (lane L2) adjacent to the traveling lane.

For example, the first recognizer 132 analyzes the camera image, extracts edge points having a large brightness difference from adjacent pixels in the image, and connecting the edge points to recognize the camera marking lines CL1 to CL3 in an image plane. The first recognizer 132 converts positions of the camera marking lines CL1 to CL3 based on a position of a reference point of the host vehicle M into positions of a vehicle coordinate system (for example, an XY plane coordinate of FIG. 3).

The first recognizer 132 may recognize, for example, a curvature (an example of a curve degree) of each of the camera marking lines CL1 to CL3. The camera marking lines CL1 to CL3 may be recognized or corrected on the basis of an output of a detection device (for example, the radar device 12 or the LIDAR 14) other than the camera 10. The first recognizer 132 may recognize a curvature change amount (an example of a curve degree) of each of the camera marking lines CL1 to CL3. The curvature change amount is, for example, a rate of change over time of a curvature of each of the camera marking lines CL1 to CL3 recognized by the camera 10 at x [m] in front as viewed from the host vehicle M. The first recognizer 132 may average the curvatures or the curvature change amounts of the respective camera marking lines CL1 to CL3 to recognize a curvature or a curvature change amount of each of the lanes defined by the camera marking lines CL1 to CL3. The camera marking lines CL1 to CL3 may be recognize or corrected on the basis of an output of a detection device (for example, the radar device 12 or the LIDAR 14) other than the camera 10.

The first recognizer 132 may recognize a degree of parallelism of the camera marking lines CL1 to CL3. The degree of parallelism is an index value indicating that the marking lines become more parallel to each other as a value of the degree of parallelism becomes greater. For example, the first recognizer 132 acquires a distance between the camera marking lines CL1 and CL2 as viewed from the host vehicle M at each prescribed distance and recognizes the degree of parallelism according to a change amount of the distance. In this case, the smaller the change amount of the distance is (the closer the change amount is to 0 or the less a change in distance is), the greater the value of the degree of parallelism becomes. The first recognizer 132 may recognize a degree of parallelism of the camera marking lines CL1 and CL3 or may recognize a degree of parallelism of the camera marking lines CL2 and CL3. In the first scene, the first recognizer 132 may recognize, for example, an object (a physical boundary, another vehicle, or the like) around the host vehicle M.

The second recognizer 134 recognizes, for example, marking lines of lanes around the host vehicle M from the map information on the basis of the position of the host vehicle M detected by the vehicle sensor 40 or the GNSS receiver 51. For example, the second recognizer 134 refers to the map information on the basis of the positional information of the host vehicle M and recognizes the map marking lines ML1 to ML3 present in a moving direction of the host vehicle M or a direction in which the host vehicle M can move.

The second recognizer 134 may recognize the map marking lines ML1 and ML2 as marking lines that define the lane L1 as the traveling lane of the host vehicle M and may recognize the map marking lines ML2 and ML3 as marking lines that define the lane L2 as the adjacent lane of the lane L1, among the recognized map marking lines ML1 to ML3. The second recognizer 134 recognizes the curvature or the curvature change amount (an example of a curve degree) of each of the map marking lines ML1 to ML3 from the second map information 62. The second recognizer 134 may average the curvatures or the curvature change amounts of the respective map marking lines ML1 to ML3 to recognize the curvature or the curvature change amount of each of the lanes defined by the map marking lines.

The determiner 142 determines whether the camera marking lines CL1 to CL3 recognized by the first recognizer 132 and the map marking lines ML1 to ML3 recognized by the second recognizer 134 deviate from each other. For example, the determiner 142 derives a deviation degree between the marking lines CL1 and ML1 present at the closest position on the left side as viewed from the host vehicle M, a deviation degree between the marking lines CL2 and ML2 present at the closest position on the right side as viewed from the host vehicle M, and a deviation degree between the marking lines CL3 and ML3 on an adjacent lane side. Then, the determiner 142 determines that the camera marking line CL and the map marking line ML deviate from each other when the derived deviation degree is equal to or greater than a threshold, and determines that the camera marking line CL and the map marking line ML do not deviate from each other when the deviation degree is less than the threshold. The determination on whether the marking lines deviate from each other may be executed repeatedly at prescribed timings or in a prescribed cycle.

For example, the determiner 142 superimposes the camera marking lines CL1, CL2, and CL3 and superimposes the map marking lines ML1, ML2, and ML3 based on the position of the representative point of the host vehicle M on a plane (XY plane) of the vehicle coordinate system. Then, in determining the marking lines (the marking lines CL1 and ML1, the marking lines CL2 and ML2, and the marking lines CL3 and ML3) to be compared, the determiner 142 determines that the marking lines deviate from each other when the deviation degree of at least one marking line is equal to or greater than the threshold, and determines that the marking lines do not deviate from each other when the deviation degrees of all marking lines are less than the threshold. The deviation degree is a degree (a deviation distance or a deviation in a width direction of the movement path) of shift amount in a road width direction (the width direction of the movement path, the lateral direction, or in the drawing, the Y-axis direction). In the example of FIG. 3, deviation determination may be performed using an average value of a shift amount D1 of lateral positions of the marking lines CL1 and ML1, a shift amount D2 of lateral positions of the marking lines CL2 and ML2, and a shift amount D3 of lateral positions of the marking lines CL3 and ML3 or deviation determination may be performed using a maximum value or a minimum value of the shift amounts D1, D2, and D3.

The deviation degree may be, for example, a degree (deviation angle) of magnitude of an angle between two marking lines to be compared, instead of (in addition to) the shift amount of the lateral positions described above. In the example of FIG. 3, an average value of an angle θ1 between the marking lines CL1 and ML1, an angle θ2 between the marking lines CL2 and ML2, and an angle θ3 between the marking lines CL3 and ML3 may be used or a maximum value or a minimum value of the angles θ1, θ2, and θ3 may be used.

The deviation degree may be a degree (magnitude) of a difference in curvature change amount of the marking lines, instead of (or in addition to) the shift amount of the lateral positions or the angle between the marking lines described above. The curvature change amount is mainly used when a lane is a curved road. For example, the determiner 142 may use an average value of a difference in curvature change amount between the marking lines CL1 and ML1, a difference in curvature change amount between the marking lines CL2 and ML2, and a difference in curvature change amount between the marking lines CL3 and ML3 or may use a maximum value or a minimum value of the differences. The determiner 142 may use a difference between an average value of the curvature change amounts of the marking lines CL1 to CL3 and an average value of the curvature change amounts of the marking lines ML1 to ML3. A difference between a curvature change amount of a lane (lane L1 or L2) recognized from the camera image and a curvature change amount of a lane recognized from the map information may be used.

The determiner 142 may adjust the threshold to prevent the determination that the camera marking line CL and the map marking line ML deviate from each other. For example, in a case where determination is made that the marking lines deviate from each other when the deviation degree is equal to or greater than the threshold, it is possible to set the threshold to be greater to prevent the determination that the marking lines deviate from each other. The threshold may be adjusted within a range set in advance, or an adjustment value may be set according to the surrounding situation, driving control in execution, an automation level, or the like.

The selector 144 selects a marking line to be a reference in generating the target trajectory or the like of the host vehicle M on the basis of a determination result of the determiner 142. For example, when the determiner 142 determines that the camera marking line CL and the map marking line ML do not deviate from each other, the selector 144 selects at least one of the camera marking line CL and the map marking line ML. In this case, the selector 144 may select one marking line (for example, the camera marking line CL) determined in advance, may select the map marking line ML when the recognition accuracy of the camera 10 is less than a threshold, or may select the camera marking line CL with older map information (for example, map information with map update date prior to prescribed date and time). The selector 144 may interpolate or adjust the position of one of the camera marking line CL and the map marking line ML by the position of the other marking line. The selector 144 may select one of the camera marking line CL and the map marking line ML with priority according to the surrounding situation or a recognized situation. For example, when the vicinity of the host vehicle M is heavy rain or night, since the camera marking line CL is difficult to be recognized, the selector 144 selects the map marking line ML. When determination is made that the camera marking line CL and the map marking line ML deviate from each other, the selector 144 selects any of the camera marking line CL and the map marking line ML. In this case, the selector 144 may select one marking line (for example, the camera marking line CL) determined in advance or may select one marking line according to the surrounding situation (including a road situation).

The traveling controller 146 determines driving control (traveling control or movement control) for the host vehicle M on the basis of recognition results of the first recognizer 132 and the second recognizer 134, a determination result of the determiner 142, the marking line selected by the selector 144, or the like and generates a target trajectory based on the determined driving control. “Determining driving control” may include, for example, determining the content (type) of driving control or determining whether to execute (to prevent) driving control. “Executing driving control” may include, for example, continuing driving control that is being already executed, in addition to switching the content of driving control and executing driving control. Preventing driving control may include not only not executing driving control but also lowering the automation level of driving control.

Here, the driving control that is executed by the traveling controller 146 includes at least first driving control and second driving control. The first driving control is, for example, driving control of executing one or both of steering control and speed control of the host vehicle M on the basis of at least one of the camera marking line CL and the map marking line ML. For example, in the LKAS control, the first driving control causes the host vehicle M to travel such that the representative point of the host vehicle M passes through the center of the lane defined by the marking lines. In the ALC control, the first driving control generates a traveling trajectory for lane change of the host vehicle M from the traveling lane (for example, the lane L1) to a lane (for example, the lane L2) of a lane change destination (traveling road change destination) and causes the host vehicle M to travel such that the representative point of the host vehicle M travels on a trajectory along the generated traveling trajectory. In the first driving control, for example, when the camera recognition accuracy is less than the threshold, driving control is performed while giving priority to the map marking line ML, and when the marking line is a marking line with old map information (for example, a marking line with map update date prior to prescribed date and time), driving control may be performed while giving priority to the camera marking line CL. Driving control may be performed according to the camera marking line CL or the map marking line ML on the basis of the determination result of the determiner 142.

The second driving control is, for example, driving control of executing one or both of the steering control and the speed control of the host vehicle M on the basis of an object (for example, a physical boundary or another vehicle) recognized by the first recognizer 132. The second driving control specifies a position of a lane, for example, on the basis of a position of a physical boundary or another vehicle and causes the host vehicle M to travel such that the representative point of the host vehicle M travels at the center of the specified lane. The second driving control causes the host vehicle M to travel such that the representative point of the host vehicle M travels on a trajectory along a traveling trajectory of another vehicle.

The driving control may include a plurality of kinds of driving control having different automation levels (an example of a degree of automation). The automation level includes, for example, a first level, a second level where the degree of automation of driving control is lower than that of the first level, and a third level where the degree of automation of driving control is lower than that of the second level. The automation level may include a fourth level where the degree of automation of driving control is lower than that of the third level. Here, the automation level may be a level determined by standardized information, regulations, or the like or may be an index value that is set independently of the standardized information, the regulations, or the like. Accordingly, the types, the contents, and the number of automation levels are not limited to the following example. A low degree of automation of driving control means, for example, that an automation rate in the driving control is low and a task imposed on the driver is large (heavy). Low automation of driving control means that a degree at which the automated driving control device 100 controls the steering or acceleration/deceleration of the host vehicle M is low (a degree at which the driver needs to intervene in a steering or acceleration/deceleration operation is high). The task imposed on the driver is, for example, monitoring of the surroundings of the host vehicle M or an operation of a driving operation member. The operation of the driving operation member includes, for example, a state (hereinafter, referred to as a hands-on state) in which the driver is gripping the steering wheel. A task imposed on the driver is, for example, a task (driver task) for an occupant necessary for maintaining the automated driving of the host vehicle M. Accordingly, when the occupant cannot execute the imposed task, the automation level is lowered. The driving control at the first level may include, for example, driving control such as ALC, LKAS, ACC, TJP, and CMBS. The driving control at the second or third level may include, for example, driving control such as ALC, LKAS, ACC, and CMBS. The driving control at the fourth level may include manual driving. In the driving control at the fourth level, for example, driving control such as ACC and CMBS may be executed. Among the first to fourth levels, the first level has a highest degree of automation of driving control, and the fourth level has a lowest degree of automation of driving control.

At the first level, since there is no task imposed on the occupant (the task imposed on the driver is the lightest), for example, driving control in a state (hereinafter, referred to as a hands-off state) in which the driver of the host vehicle M is not gripping the steering wheel is allowed. A task imposed on the driver at the second level is, for example, monitoring the surroundings (in particular, an area in front) of the host vehicle M. A task imposed on the driver at the third level is, for example, being in the hands-on state, in addition to monitoring the surroundings of the host vehicle M. A task imposed on the driver at the fourth level is, for example, an operation to control the steering and the speed of the host vehicle M by the driving operation member 80, in addition to monitoring of the surroundings of the host vehicle M and being in the hands-on state. That is, at the fourth level, the occupant can immediately take over driving, and the task imposed on the driver is the heaviest. The content of the driving control or the task imposed on the occupant at each automation level is not limited to the above-described example. The automated driving control device 100 executes the driving control at any level of the first to fourth levels on the basis of the surrounding situation of the host vehicle M or the task being executed by the occupant.

For example, the traveling controller 146 executes the first driving control when the camera marking line CL and the map marking line ML are recognized by the recognizer 130 (the first recognizer 132 and the second recognizer 134), and executes the second driving control when at least one of the camera marking line CL and the map marking line ML is not recognized or when a physical boundary or another vehicle is present around the host vehicle M. The traveling controller 146 may perform control of switching the driving control from the first driving control to the second driving control or may perform control of ending the driving control for the host vehicle M, performing switching to the manual driving of the occupant, and the like, for example, when a prescribed condition is satisfied. The traveling controller 146 may switch the automation level according to the surrounding situation or the type of driving control.

### Second Scene

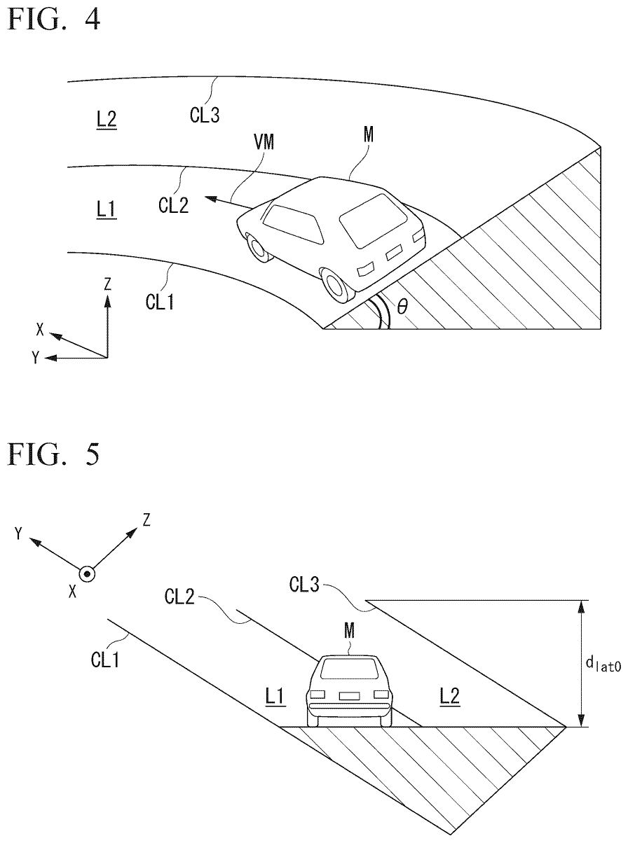

Next, driving control of the host vehicle M in a second scene will be described. In the second scene, a scene in which the host vehicle M is traveling on a road with a longitudinal slope or a lateral slope is shown. Here, an influence on a height of a marking line due to a longitudinal slope and a lateral slope will be described. FIG. 4 is a diagram illustrating traveling on a road with a slope in the second scene. The road shown in FIG. 4 is a left curved road in which lanes L1 and L2 have a lateral slope at an angle θ [rad]. When the host vehicle M is traveling on the road shown in FIG. 4, the appearance of the camera marking line CL (the position of the camera marking line CL recognized from the camera image) may change due to the influence of the slope.

FIG. 5 is a diagram illustrating an influence on the appearance of a camera marking line due to a lateral slope near the host vehicle M. In the example of FIG. 5, the scene shown in FIG. 4 is viewed from a YZ plane direction. The example of FIG. 5 shows the appearance (the positions recognized by the first recognizer 132) of the camera marking lines CL1 to CL3 near the host vehicle M (within a first prescribed distance from the host vehicle M). In FIG. 5, an inclination of a traveling surface when the host vehicle M is on the lane L1 is corrected (turned right) to be horizontal. Since there is little influence due to the slope near the host vehicle, the camera marking line CL appears at the substantially same position as a marking line actually drawn on the road (or the map marking line ML). Hereinafter, height information (a deviation amount from a reference position) of a road surface caused by the influence of the lateral slope near the host vehicle M is referred to as dₗₐₜ₀. The height dₗₐₜ₀ of the road surface may be determined by each of the camera marking line CL3 on an outside of a turn and the camera marking line CL1 on an inside of a turn or may be an average of the heights of the respective camera marking lines CL1 and CL3.

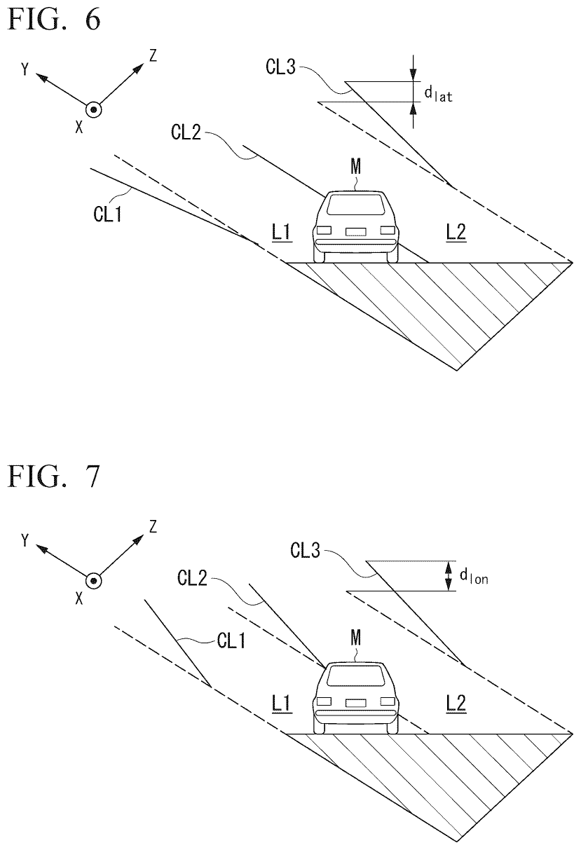

FIG. 6 is a diagram illustrating an influence on the appearance of a camera marking line CL due to a lateral slope at a position away from the host vehicle M. As shown in the example of FIG. 6, at a position away from the host vehicle M (a position farther from the host vehicle M than the first prescribed distance), it is expected that the camera marking line CL1 (a marking line at a position lower than the host vehicle M) on a left side as viewed from the host vehicle M appears to be inclined to an inside of a turn (left curve) of the road due to a shape recognition error or the like with an increase in distance from the host vehicle M according to a lateral scope of the road (lane L1 or L2). On the contrary, it is expected that the camera marking line CL3 (a marking line at a position higher than the host vehicle M) on a right side as viewed from the host vehicle M appears to be inclined to an outside of a turn with an increase in distance from the host vehicle M. It is expected that an inclination amount becomes greater as the lateral scope is greater, and becomes greater as the distance from the host vehicle M is farther.

Hereinafter, a height (deviation amount) of the road surface caused by the influence of the lateral scope at a second prescribed distance far away from the host vehicle M is referred to as dₗₐₜ. A value obtained by the height dₗₐₜ₀ and the height dₗₐₜ is an example of a “lateral slope influence degree”. The height dₗₐₜ of the road surface may be determined by each of the camera marking line CL3 on an outside of a turn and the camera marking line CL1 on an inside of a turn or may be an average of the heights of the respective camera marking lines CL1 and CL3.

FIG. 7 is a diagram illustrating an influence on the appearance of a camera marking line due to a longitudinal slope of the host vehicle M. The example of FIG. 7 shows a case where a height at the center of a road increases toward the moving direction (a longitudinal direction of the road) of the host vehicle M (that is, an uphill road: hereinafter, referred to “height+”). In a case where the height in the moving direction increases, at a position away from the host vehicle M by a third prescribed distance or more as shown in FIG. 7, it is expected that all the marking lines CL1 to CL3 appear to be inclined to an outside (a right side with respect to a dotted line in the drawing) of a turn due to a shape recognition error or the like. On the contrary, in a case where the height at the center of the road decreases in the moving direction of the host vehicle M (that is, a downhill road: hereinafter, referred to as “height−”), it is expected that all the marking lines CL1 to CL3 appear to be inclined to an inside (a left side with respect to a dotted line in the drawing) of a turn due to a shape recognition error or the like. It is expected that an inclination amount becomes greater as the longitudinal slope is greater, and becomes greater as the distance from the host vehicle M is farther. Hereinafter, a height (a deviation amount) of a road surface caused by the longitudinal slope at the third prescribed distance is referred to as dₗₒₙ. The height dₗₒₙ is an example of a “longitudinal slope influence degree”. The height dₗₒₙ of the road surface may be determined by each of the camera marking line CL3 on an outside of a turn and the camera marking line CL1 on an inside of a turn or may be an average of the heights of the respective camera marking lines CL1 to CL3.

Accordingly, in the second scene, when the road on which the vehicle is traveling has a longitudinal slope or a lateral slope, the determiner 142 predicts a direction (deviation direction) in which the camera marking line CL deviates from an actual marking line (or the map marking line ML) due to a shape recognition error or the like, on the basis of each of the longitudinal slope influence degree (dₗₒₙ) and the lateral slope influence degree (dₗₐₜ₀+dₗₐₜ), and performs deviation determination between the camera marking line CL and the map marking line ML while including information (result) of the predicted deviation direction.

When the map information includes the height information at the center of the road, but does not include longitudinal slope information, in the embodiment, the longitudinal slope is replaced with the height information at the center of the road. In this case, since the height information is set at each prescribed distance, the determiner 142 calculates a longitudinal slope by dividing a difference value in height at the prescribed distance by the prescribed distance and derives the longitudinal slope influence degree (dₗₒₙ) from the calculated longitudinal slope.

When the map information does not include lateral slope information, from curve degree information (for example, a curvature) and a road surface slope having a correspondence relationship, replacement is made by predicting a lateral slope from a curvature. In this case, since as the curvature becomes greater within a prescribed range, the lateral scope becomes greater in proportion thereto, the determiner 142 predicts a lateral slope according to a curvature value according to the correspondence relationship and derives the lateral slope influence degree (dₗₐₜ₀+dₗₐₜ) from the predicted lateral slope. When the curvature is equal to or greater than a prescribed value, the lateral slope is made constant at an upper limit value.

### Deviation Determination Based on Prediction of Deviation Direction of Camera Marking Line CL

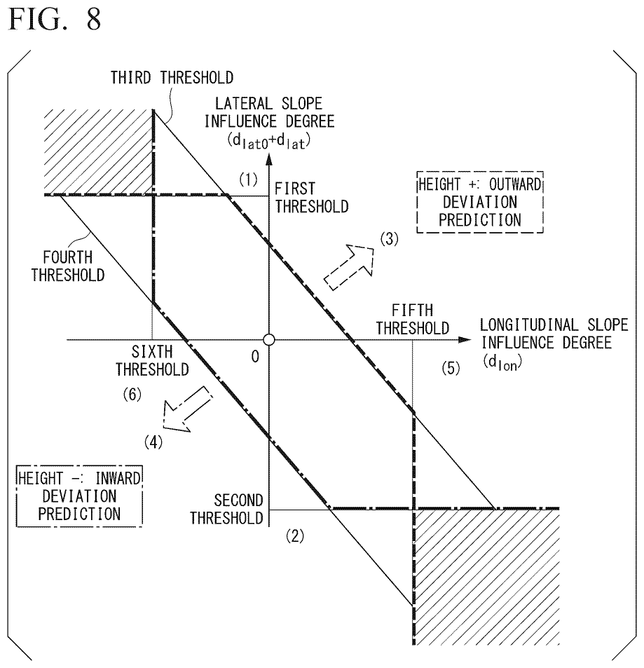

Next, deviation determination processing of the determiner 142 based on prediction of a deviation direction of the camera marking line CL in the second scene will be specifically described. In the second scene, when the map information includes height information and curve degree information of the road, and when the height information and the curve degree information satisfy prescribed conditions, the determiner 142 performs control of preventing determination that the camera marking line CL and the map marking line ML deviate from each other. “Preventing determination” includes, for example, adjusting a threshold for deviation determination or adjusting an area to be determined to prevent determination that the marking lines deviate from each other. Specifically, when determination is that a longitudinal slope influence degree (dₗₒₙ) in a pitch direction of the host vehicle M obtained from the height information and a lateral slope influence degree (dₗₐₜ₀+dₗₐₜ) in a roll direction obtained from the curve degree information satisfy prescribed conditions, the determiner 142 performs control of preventing determination that the camera marking line CL and the map marking line ML deviate from each other. As a result, it is possible to prevent a slope influence for deviation determination, and to prevent excessive deviation determination. Hereinafter, a specific example of the prescribed condition will be described with reference to FIG. 8.

FIG. 8 is a diagram illustrating a prescribed condition for the longitudinal slope influence degree and the lateral slope influence degree in the embodiment. In the example of FIG. 8, the horizontal axis indicates the longitudinal slope influence degree (dₗₒₙ), and the vertical axis indicates the lateral slope influence degree (dₗₐₜ₀+dₗₐₜ). Hereinafter, a plurality of prescribed conditions will be described with reference to FIG. 8.

Condition (1): Height Increases with Influence of Lateral Slope

A condition (1) is a case where the lateral slope influence degree (dₗₐₜ₀+dₗₒₙ) is a first threshold. The first threshold is a fixed value greater than 0 (zero), for example. For the condition (1), it is estimated that the lateral slope of the road is large with the lateral slope influence degree, and the height of one of the left and right camera marking lines increases with the lateral slope (“height+” shown in FIG. 8). This corresponds to the situation of the camera marking line CL3 shown in FIG. 6. For this reason, it is predicted that the camera marking line CL deviates outward (to an outside of a turn) from an actual marking line (or the map marking line). Accordingly, when the condition (1) is satisfied, the determiner 142 determines that there is an influence of a slope, and prevents determination that the camera marking line CL and the map marking line ML deviate from each other.

Condition (2): Height Decreases with Influence of Lateral Slope

A condition (2) is a case where the lateral slope influence degree (dₗₐₜ₀+dₗₒₙ) is less than a second threshold. The second threshold is a fixed value smaller than 0, for example. For the condition (2), it is estimated that the lateral slope of the road is large with the lateral slope influence degree, and the height of one of the left and right camera marking lines decreases with the lateral slope (“height−” shown in FIG. 8). This corresponds to the situation of the camera marking line CL1 shown in FIG. 6. It is predicted that the camera marking line CL deviates inward (to an inside of a turn) from the actual marking line (or the map marking line). Accordingly, when the condition (2) is satisfied, the determiner 142 determines that there is an influence of a slope, and prevents determination that the camera marking line CL and the map marking line ML deviate from each other.

### Condition (3): Height of Sum of Longitudinal and Lateral Slopes Increases

A condition (3) is a case where a value (dₗₐₜ₀+dₗₐₜ+dₗₒₙ) obtained by adding the longitudinal slope influence degree and the lateral slope influence degree is greater than a third threshold. The third threshold is a value indicated by a straight line in a two-dimensional coordinate system composed of the longitudinal slope influence degree (dₗₒₙ) and the lateral slope influence degree (dₗₐₜ₀+dₗₐₜ) as shown in FIG. 8. That is, the threshold is different according to the value of each of the longitudinal slope influence degree and the lateral slope influence degree. For the condition (3), it is expected that a position where the camera marking line CL is recognized by the first recognizer 132 changes due to both slope influence degrees. When the condition (3) is satisfied, it is predicted that the camera marking line CL deviates outward (to an outside of a turn) from an actual marking line (or the map marking line). Accordingly, when the condition (3) is satisfied, the determiner 142 determines that there is an influence of a slope, and prevents determination that the camera marking line CL and the map marking line ML deviate from each other.

### Condition (4): Height of Sum of Longitudinal and Lateral Slopes Decreases

A condition (4) is a case where the value (dₗₐₜ₀+dₗₐₜ+dₗₒₙ) obtained by adding the longitudinal slope influence degree and the lateral slope influence degree is less than a fourth threshold. The fourth threshold is a value indicated by a straight line in a two-dimensional coordinate system composed of the longitudinal slope influence degree (dₗₒₙ) and the lateral slope influence degree (dₗₐₜ₀+dₗₐₜ) as shown in FIG. 8, and is a threshold smaller than the third threshold. In this case, similarly to the condition (3), it is expected that the appearance of the camera marking line by the first recognizer 132 changes due to both slope influence degrees. When the condition (3) is satisfied, it is predicted that the camera marking line CL deviates inward (to an inside of a turn) from an actual marking line (or the map marking line). Accordingly, when the condition (4) is satisfied, the determiner 142 determines that there is an influence of a slope, and prevent determination that the camera marking line CL and the map marking line ML deviate from each other.

### Condition (5): Road Surface Height Increases Due to Influence of Longitudinal Slope

A condition (5) is a case where the longitudinal slope influence degree (dₗₒₙ) is greater than a fifth threshold. The fifth threshold is, for example, a fixed value greater than 0. For the condition (5), it is estimated that the longitudinal slope of the road is large with the longitudinal slope influence degree, and when a value based on a height is large, an upslope is large. For this reason, when the condition (5) is satisfied, the determiner 142 prevents determination that the camera marking line CL and the map marking line ML deviate from each other.

### Condition (6): Road Surface Height Decreases Due to Influence of Longitudinal Slope

A condition (6) is a case where the longitudinal slope influence degree (dₗₒₙ) is less than a sixth threshold. The sixth threshold is, for example, a fixed value smaller than 0. When a value based on a height is small, it is estimated that a downslope is large. For this reason, when the condition (6) is satisfied, the determiner 142 prevents determination that the camera marking line CL and the map marking line ML deviate from each other.

Each of the conditions (1) to (6) described above may be combined with other conditions without change or with modification. For example, when the lateral slope influence degree is equal to or less than the first threshold, and the longitudinal slope influence degree is equal to or less than the fifth threshold, a case where the value obtained by adding the longitudinal slope influence degree and the lateral slope influence degree is greater than the third threshold may be applied as the above-described condition (3). As a result, even when the slope influence degree is small only with any of the longitudinal slope and the lateral slope, it is possible to reflect a slope influence degree as the entire road using the sum.

When the lateral slope influence degree is equal to or greater than the second threshold, and the longitudinal slope influence degree is equal to or greater than the sixth threshold, a case where the value obtained by adding the longitudinal slope influence degree and the lateral slope influence degree is less than the fourth threshold may be applied as the above-described condition (4). With this, even when the slope influence degree is large only with any of the longitudinal slope and the lateral slope, it is possible to reflect a slope influence degree as the entire road using the sum.

When any condition of the conditions (1) to (6) described above is satisfied, the determiner 142 may predict that the camera marking line CL recognized by the first recognizer 132 deviates to one side or the other side in the road width direction (movement path width direction), compared to when all the conditions (1) to (6) are not satisfied. When a predicted deviation direction (predicted direction) and a deviation direction of the camera marking line CL actually recognized by the first recognizer 132 with respect to the map marking line ML match each other (including a prescribed error allowable range), the determiner 142 may perform control of preventing determination that the camera marking line CL and the map marking line ML deviate from each other. As a result, since determination can be made that the camera marking line CL recognized by the first recognizer 132 is based on a slope influence when the predicted direction and the deviation direction match each other, it is possible to prevent excessive deviation determination by preventing determination that the camera marking line CL and the map marking line ML deviate from each other.

### Other Conditions

As another condition, for example, the prescribed condition may be a case where the height information and the curve degree information are greater than prescribed values. More specifically, in the example of FIG. 8, the prescribed condition may be a case where the lateral slope influence degree is greater than the first threshold and the longitudinal slope influence degree is less than the sixth threshold (a hatched portion on an upper left side in the drawing) or a case where the lateral slope influence degree is less than the second threshold and the longitudinal slope influence degree is greater than the fifth threshold (a hatched portion on a lower right side in the drawing). For this condition, the signs of the longitudinal slope influence degree and the lateral slope influence degree may be reversed, and when positive and negative values are combined, “height+” and “height−” may not be distinguished. For this reason, when the above-described condition is satisfied, the determiner 142 predicts the camera marking line CL recognized by the first recognizer 132 is likely to deviate in both directions of one side and the other side in the road width direction (movement path width direction). “Likely to deviate in both directions of one side and the other side” indicates that the camera marking line CL is likely to deviate to one side (for example, to an inside of the road) in the road width direction and is likely to deviate to the other side (for example, an outside of the road) in the road width direction. That is, when the above-described condition is satisfied, determination is apt to be made that the camera marking line CL and the map marking line ML deviate from each other, compared to when the above-described condition is not satisfied. As described above, when the predicted deviation direction and the direction of the camera marking line CL (the deviation direction of the camera marking line CL with respect to the map marking line ML) actually recognized by the first recognizer 132 match each other, the determiner 142 prevents determination that the camera marking line CL and the map marking line ML deviate from each other. As a result, it is possible to prevent excessive deviation determination even under a condition as described above.

### Modification Example of Determiner

For example, since the heights of the marking line on the inside of the turn and the marking line on the outside of the turn are different in a curve road where a curve degree is equal to or greater than the threshold (the marking line on the outside of the turn is higher than the marking line on the inside of the turn), the determiner 142 may perform the above-described determination processing separately for the marking lines. As a result, it is possible to improve determination accuracy.

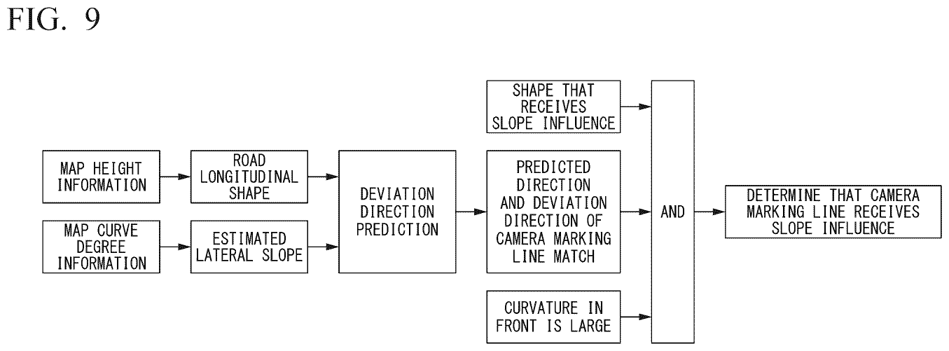

The determiner 142 may determine whether the camera marking line CL is under a slope influence, on the basis of the predicted direction and the deviation direction of the camera marking line CL corresponding to the above-described conditions, other conditions, and the like. FIG. 9 is a diagram illustrating determination on whether the camera marking line CL is under a slope influence. In the example of FIG. 9, the determiner 142 acquires a shape in a road longitudinal direction (longitudinal direction, extension direction) from the height information (map height information) obtained from the map information, and acquires an estimated lateral slope from the curve degree information (map curve degree information) obtained from the map information. Next, the determiner 142 predicts a deviation direction under the above-described condition on the basis of the road longitudinal shape and the estimated lateral slope information, and determines whether the predicted direction and the deviation direction of the camera marking line CL recognized by the first recognizer 132 with respect to the map marking line ML match each other.

When the predicted direction and the deviation direction match each other, and when a road shape is a shape that receives a slope influence determined in advance, and a curvature (curve degree) in front of the host vehicle M is large (equal to or greater than the threshold), the determiner 142 determines that the camera marking line CL is under the influence of the road slope. As a result, it is possible to execute more appropriate deviation determination or driving control according to the presence or absence of the slope information.

As another modification example, the determiner 142 may directly use the height information and the curve degree information to perform comparison with the corresponding thresholds, in addition to (instead of) the above-described condition, and may predict whether the camera marking line CL deviates to one side or the other side in the road width direction, on the basis of a comparison result. In determination of the slope influence directly using the height information and the curve degree information, accuracy is assumed to be degraded compared to when the slope influence degree is used.

Thus, it is preferable that the determiner 142 is restricted to use any value in a situation in which a value equal to or greater than the threshold is output. For example, when the height information and the curve degree information are greater than the prescribed values, and when the corresponding prescribed condition is satisfied, the determiner 142 predicts a deviation of the camera marking line CL recognized by the first recognizer 132 to both sides of one side and the other side in the road width direction, compared to when the prescribed condition is not satisfied. Then, when the predicted deviation direction and the direction of the camera marking line CL recognized by the first recognizer 132 (the deviation direction of the camera marking line CL with respect to the map marking line ML) match each other, the determiner 142 prevents determination that the camera marking line CL and the map marking line ML deviate from each other. As a result, it is possible to perform more appropriate deviation determination using the height information and the curve degree information.

### Selector

Next, details of the processing of the selector 144 will be described. For example, since the camera marking line CL recognized on the basis of the camera image of the camera 10, or the like is influenced by the road slope as described above, a recognition error of the camera marking line CL occurs, and the camera marking line CL is likely to deviate from the actual marking line (or the map marking line ML). In traveling on a curved road, in the related art, when a degree of parallelism is equal to or greater than a threshold on the basis of parallelism of left and right camera marking lines as viewed from the host vehicle M, the camera marking line is selected as a correct marking line, and when the degree of parallelism is less than the threshold, the map marking line is selected. However, when the shape of the road of the host vehicle M has a slope, since an error occurs in shape recognition of the marking line, an incorrect marking line may be selected.

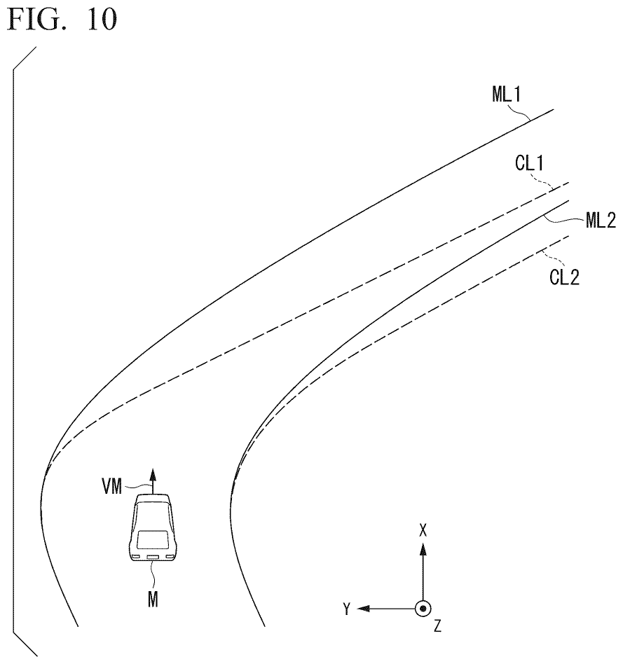

FIG. 10 is a diagram illustrating the shapes of the camera marking line CL and the map marking line ML as viewed from the host vehicle M that is traveling on a curved road. As shown in FIG. 10, since the camera marking line CL1 and the map marking line ML1, and the camera marking line CL2 and the map marking line ML2 to be compared deviate from each other, while one of the marking lines is selected, a shape recognition error occurs in the camera marking line CL due to the influence of the slope. Thus, the map marking lines ML1 and ML2 should be selected, but since the degree of parallelism of the left and right camera marking lines CL1 and CL2 is equal to or greater than the threshold, the camera marking line is selected incorrectly. Accordingly, in the embodiment, the selector 144 selects the map marking line ML when determination is made that the camera marking line CL receives the slope influence.

For example, the selector 144 predicts the deviation direction of the camera marking line CL by the slope influence degree (longitudinal slope influence degree and the lateral slope influence degree) from the map information when the determiner 142 determines that the camera marking line CL and the map marking line ML deviate from each other, and selects the map marking line ML when the predicted direction and the deviation direction of the camera marking line CL recognized by the first recognizer 132 with respect to the map marking line ML match each other.

More specifically, the selector 144 selects the map marking lines ML1 and ML2, for example, when the determiner 142 determines that the camera marking line CL and the map marking line ML deviate from each other, the degree of parallelism of a plurality of camera marking lines CL1 and CL2 present in the moving direction of the host vehicle M recognized by the first recognizer 132 is equal to or greater than the threshold, and the height (the height of the road in the moving direction of the host vehicle M) of the road (the road surface of the movement path) on which the host vehicle M is traveling is decreasing (the road is a downhill road). Determination on whether the height of the road is decreasing may be performed on the basis of, for example, the height information at the center of the road included in the map information. Alternatively, longitudinal slope information may be acquired from the height information, and determination may be performed using the acquired longitudinal slope information. When the map information includes the longitudinal slope information, determination may be made whether the height of the road is decreasing, on the basis of the longitudinal slope information.

As a result, even in a situation in which the camera marking line CL recognized by the first recognizer 132 is recognized as a shape different from an actual shape due to the influence of the road slope, and determination is made that the camera marking line of which the appearance changes is horizontal, it is possible to select the map marking line ML. Accordingly, it is possible to perform driving control using information regarding a marking line with higher accuracy.

The selector 144 selects the camera marking line CL when the height of the road on which the host vehicle M is traveling is not decreasing (when the road is not a downhill road) even when determination is made that the camera marking line CL and the map marking line ML deviate from each other, and the degree of parallelism is equal to or greater than the threshold. When the slope is not a downslope, the degree of parallelism is less likely to be equal to or greater than the threshold due to the influence of the slope, it is possible to select a marking line with higher accuracy by selecting the parallel camera marking lines CL as a correct marking line to the contrary.

For example, when the road on which the host vehicle Mis traveling is a curved road (for example, the curvature is equal to or greater than the prescribed value) on the basis of the curve degree information included in the map information, and the camera marking line CL recognized by the first recognizer 132 deviates to the inside of the turn with respect to the map marking line ML, even when the degree of parallelism of the plurality of camera marking lines CL1 and CL2 is equal to or greater than the threshold, the selector 144 may select the map marking line ML when the height of the road is decreasing. In determination on whether the road is a curved road, the lateral scope information may be acquired on the basis of the curve degree, and the determination may be performed using the acquired lateral slope information. When the map information includes the lateral slope information, the determination on whether the road is a curved road may be performed on the basis of the lateral slope information.

As a result, when the height of the road is decreasing, since the camera marking line CL recognized by the first recognizer 132 is likely to be recognized to deviate to the inside of the turn with respect to the map marking line ML, it is possible to select the map marking line ML in a more appropriate road situation by adding a deviation of the camera marking line CL to the inside of the turn with respect to the map marking line ML to the condition for selecting the map marking line ML.

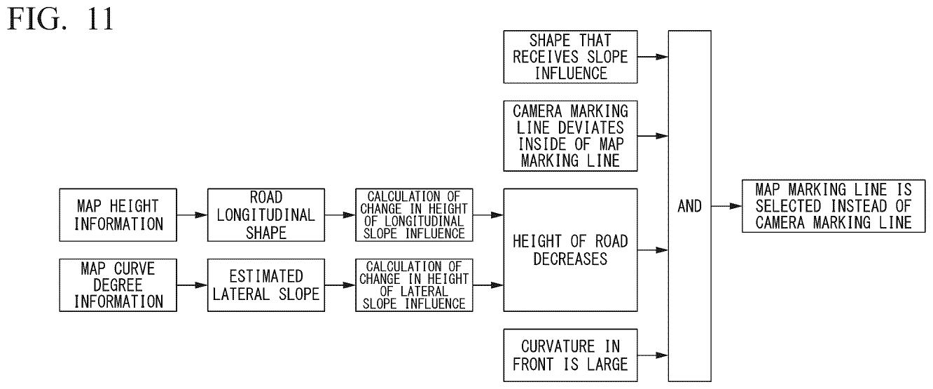

Here, an example where the map marking line is selected instead of the camera marking line in the selector 144 will be described. FIG. 11 is a diagram showing an example of marking line selection by the selector 144. The example of FIG. 11 also shows an example of processing of the determiner 142. In the example of FIG. 11, the determiner 142 acquires the shape in the road longitudinal direction from the height information (map height information) obtained from the map information, and acquires the estimated lateral slope from the curve degree information (map curve degree information) obtained from the map information. Next, the determiner 142 calculates change in height (for example, the above-described longitudinal slope influence degree) of the longitudinal slope influence from the road longitudinal shape, and calculates change in height (for example, the above-described lateral slope influence degree) of lateral scope influence on the basis of the estimated lateral slope. The determiner 142 determines whether the height of the road on which the host vehicle Mis traveling is decreasing, on the basis of a calculation result of each of the change in height of the longitudinal slope influence and the change in height of the lateral slope influence.

Then, when determination is made that the height of the road is decreasing, the traveling road of the host vehicle M has a shape that receives the slope influence determined in advance, the camera marking line CL deviates inward the map marking line ML, and the curvature (curve degree) in front of the host vehicle M is large (equal to or greater than the threshold), the selector 144 selects the map marking line ML instead of the camera marking line CL. As a result, it is possible to more appropriately select a marking line that defines a lane on which the host vehicle M is traveling, according to the presence or absence of the slope influence. Accordingly, it is possible to execute more appropriate driving control according to a surrounding road situation.

### Processing Flow

Hereinafter, processing that is executed by the automated driving control device 100 of the embodiment will be described. Hereinafter, driving control processing based on a recognition situation of a marking line, or the like out of the processing to be executed by the automated driving control device 100 will be mainly described. It is assumed that prescribed driving control (for example, LKAS control in a first driving state (for example, the driver is in a hands-off state)) is being executed in the host vehicle M. The following processing may be repeatedly executed at prescribed timings or in a prescribed cycle (for example, during the execution of the driving control by the automated driving control device 100).

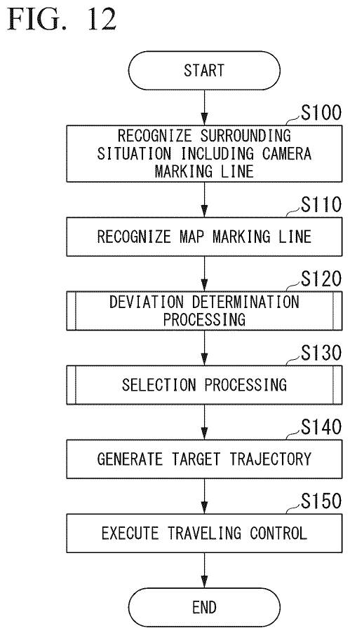

FIG. 12 is a flowchart illustrating an example of a flow of driving control processing in the embodiment. In the example of FIG. 12, the first recognizer 132 recognizes the surrounding situation including a marking line (camera marking line) around the host vehicle M on the basis of the output of the detection device DD that detects the surrounding situation of the host vehicle M (Step S100). In the processing of Step S100, for example, an object (for example, a physical boundary or another vehicle) around the host vehicle M may be recognized. Next, the second recognizer 134 refers to the map information on the basis of the positional information of the host vehicle M and recognizes a marking line (map marking line) around the host vehicle M from the map information (Step S110).

Next, the determiner 142 performs deviation determination on whether the camera marking line CL and the map marking line ML deviate from each other (Step S120). The processing of Step S120 will be described below. Next, the selector 144 executes selection processing of selecting the marking line on the basis of a determination result of the determiner 142 (Step S130). The processing of Step S130 will be described below. Next, the traveling controller 146 generates a target trajectory such that the host vehicle M travels along the selected marking line (Step S140), and causes the second controller 160 to travel the host vehicle M to along the generated target trajectory (Step S150). As a result, the processing of this flowchart ends.

### Deviation Determination Processing (Step S120)

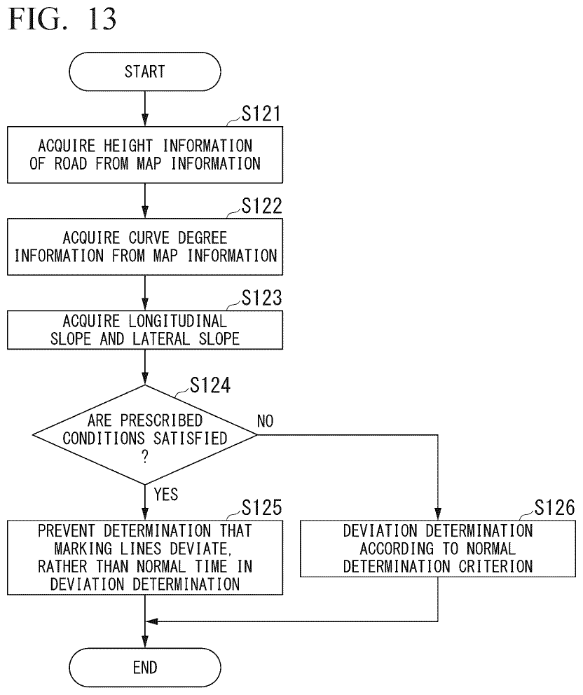

FIG. 13 is a flowchart illustrating an example of deviation determination processing. In the example of FIG. 13, the determiner 142 acquires the height information of the road on which the host vehicle M is traveling, from the map information on the basis of the positional information of the host vehicle M (Step S121). Next, the determiner 142 acquires the curve degree information of the road on which the host vehicle is traveling, from the map information (Step S122). Next, the determiner 142 acquires (calculates) the longitudinal slope from the height information, and acquires (predicts) the lateral slope from the curve degree (Step S123). Next, the determiner 142 determines whether the longitudinal slope and the lateral slope satisfy the prescribed conditions (Step S124). When determination is made that the prescribed conditions are satisfied, the determiner 142 adjusts the threshold or the like in the deviation determination and prevents determination that the camera marking line CL and the map marking line ML deviate from each other rather than a normal time (Step S125). When determination is made that the prescribed conditions are not satisfied, the determiner 142 performs deviation determination according to a normal determination criterion (threshold) or the like (Step S126). As a result, the processing of this flowchart ends.

### Selection Processing (Step S130)

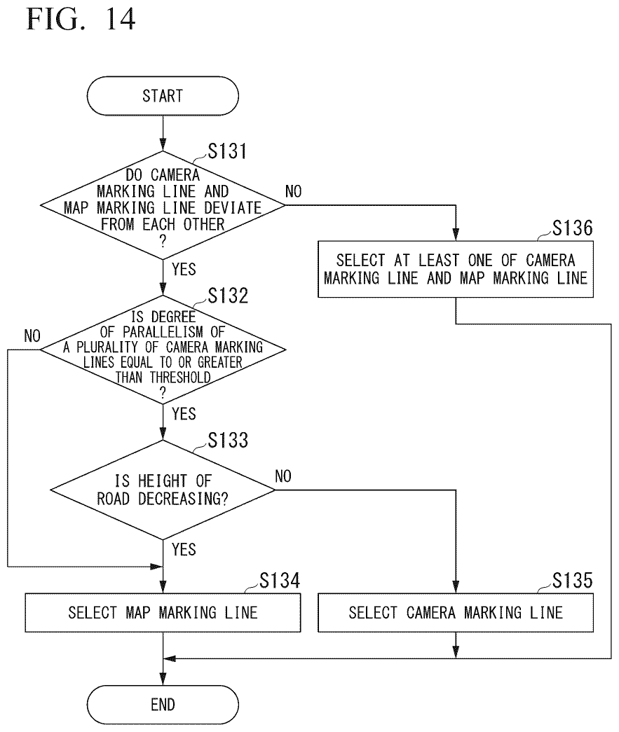

FIG. 14 is a flowchart illustrating an example of selection processing. In the example of FIG. 14, the selector 144 determines whether the camera marking line CL and the map marking line ML deviate from each other, on the basis of a determination result of the determiner 142 (Step S131). When determination is made that the marking lines deviate from each other, the selector 144 determines whether the degree of parallelism of a plurality of camera marking lines CL is equal to or greater than the threshold, on the basis of a recognition result of the first recognizer 132 (Step S132). When determination is made that the degree of parallelism is equal to or greater than the threshold, the selector 144 determines whether the height of the road (the road surface in the moving direction) on which the host vehicle M is traveling is decreasing (downhill road) (Step S133). When determination is made that the height of the road is decreasing, the selector 144 selects the map marking line ML as a marking line to be a reference for the driving control of the host vehicle M (Step S134). In the processing of Step S132, when determination is made that the degree of parallelism of a plurality of camera marking lines is not equal to or greater than the threshold, the selector 144 also selects the map marking line ML (Step S134).

In the processing of Step S133, when determination is made that the height of the road surface is not decreasing, the selector 144 selects the camera marking line as a marking line to be a reference for traveling of the host vehicle M (Step S135). In the processing of Step S131, when determination is made that the camera marking line CL and the map marking line ML do not deviate from each other, the selector 144 selects at least one of the camera marking line CL and the map marking line ML (Step S136). In the processing of Step S136, one marking line set in advance may be selected or both marking lines may be selected and traveling control may be executed on the basis of information on both marking lines (or by interpolating the position of one marking line with the position of the other marking line). A more accurate marking line may be selected according to recognition accuracy, an update history of the map information, or the like. As a result, the processing of this flowchart ends.

### Modification Example

In the above-described embodiment, while the deviation direction in which the marking lines deviate from each other due to the shape recognition error is predicted or control of preventing determination that the marking lines deviated from each other according to conditions that the longitudinal slope influence degree and the lateral slope influence degree satisfy, among a plurality of conditions set in advance, the deviation direction may be acquired by inputting the longitudinal slope influence degree and the lateral slope influence degree or the height information and the curve degree information of the road using a function. A trained model with the longitudinal slope influence degree and the lateral slope influence degree or the height information and the curve degree information of the road as an input and the deviation direction as an output may be generated in advance by machine learning or the like, and the deviation direction may be acquired using the generated trained model.

According to the above-described embodiment, the determination device includes the first recognizer 132 configured to recognize the surrounding situation including the camera marking line (an example of a first marking line) for defining the movement path along which the host vehicle M is moving, on the basis of an output of the detection device DD that detects the surrounding situation of the host vehicle M (an example of a mobile object), the second recognizer 134 configured to recognize the map marking line (an example of a second marking line) for defining the movement path around the mobile object from the map information on the basis of the positional information of the host vehicle M, and the determiner 142 configured to determine whether the camera marking line and the map marking line deviate from each other, in which the map information includes the height information and the curve degree information of the movement path, and the determiner 142 is configured to prevent determination that the camera marking line and the map marking line deviate from each other when the height information and the curve degree information satisfy the prescribed condition. Therefore, it is possible to more appropriately perform deviation determination of marking lines according to the situation of the movement path. In turn, it is possible to contribute to development of a sustainable transportation system. Specifically, according to the embodiment, for example, it is possible to estimate a road slope to a certain extent with the height and the magnitude of the curve degree of the road even when slope information is not obtained as map information. For this reason, with the use of the height information and curve degree information, it is possible to prevent determination that the marking lines deviate from each other when the vehicle is traveling on a road with a large slope, and to prevent an influence when the appearance of a road marking line in a road with a slope deviates from an actual shape of the road marking line even when the slope information has not been obtained. As a result, it is possible to select a more appropriate marking line on the basis of a deviation determination result, and to allow the host vehicle M to travel along the selected marking line.

The above-described embodiment can be expressed as follows.
A determination device including
a storage medium that stores computer-readable instructions, and
a processor connected to the storage medium,
in which the processor executes the computer-readable instructions to
recognize a surrounding situation including a first marking line for defining a movement path along which a mobile object is moving, on the basis of an output of a detection device that detects a surrounding situation of the mobile object,
recognize a second marking line for defining a movement path around the mobile object from map information on the basis of positional information of the mobile object, and
determine whether the first marking line and the second marking line deviate from each other,
the map information includes height information and curve degree information of the movement path, and
when the height information and the curve degree information satisfy a prescribed condition, determination that the first marking line and the second marking line deviate from each other is prevented.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A determination device comprising:
a first recognizer configured to recognize a surrounding situation including a first marking line for defining a movement path along which a mobile object is moving, on the basis of an output of a detection device that detects a surrounding situation of the mobile object;
a second recognizer configured to recognize a second marking line for defining a movement path around the mobile object from map information on the basis of positional information of the mobile object; and
a determiner configured to determine whether the first marking line and the second marking line deviate from each other,
wherein the map information includes height information and curve degree information of the movement path, and
the determiner is configured to prevent determination that the first marking line and the second marking line deviate from each other when the height information and the curve degree information satisfy a prescribed condition.

2. The determination device according to claim 1,
wherein the determiner is configured to
predict that the first marking line recognized by the first recognizer deviates to one side or the other side in a movement path width direction when determination is made that the prescribed condition is satisfied compared to when the prescribed condition is not satisfied, and
prevent the determination that the first marking line and the second marking line deviate from each other when a predicted deviation direction and a direction of the first marking line match each other.

3. The determination device according to claim 2,
wherein the height information is height information at a center of the movement path.

4. The determination device according to claim 2,
wherein the determiner is configured to perform determination using the prescribed condition in each of a marking line on an outside of a turn and a marking line on an inside of a turn of the movement path.

5. The determination device according to claim 2,
wherein the determiner is configured to prevent the determination that the first marking line and the second marking line deviate from each other when a longitudinal slope influence degree in a pitch direction of the mobile object based on the height information and a lateral slope influence degree in a roll direction of the mobile object based on the curve degree information satisfy the prescribed condition.

6. The determination device according to claim 5,
wherein the prescribed condition includes a case that the lateral slope influence degree is greater than a first threshold greater than 0.

7. The determination device according to claim 5,
wherein the prescribed condition includes a case where the lateral slope influence degree is less than a second threshold smaller than 0.

8. The determination device according to claim 5,
wherein the prescribed condition includes a case where a value obtained by adding the longitudinal slope influence degree and the lateral slope influence degree is greater than a third threshold.

9. The determination device according to claim 5,
wherein the prescribed condition includes a case where a value obtained by adding the longitudinal slope influence degree and the lateral slope influence degree is less than a fourth threshold.

10. The determination device according to claim 5,
wherein the prescribed condition includes a case where the longitudinal slope influence degree is greater than a fifth threshold greater than 0.

11. The determination device according to claim 5,
wherein the prescribed condition includes a case where the longitudinal slope influence degree is less than a sixth threshold smaller than 0.

12. The determination device according to claim 5,
wherein the prescribed condition includes a case where the lateral slope influence degree is equal to or less than a first threshold, the longitudinal slope influence degree is equal to or less than a fifth threshold, and a value obtained by adding the longitudinal slope influence degree and the lateral slope influence degree is greater than a third threshold.

13. The determination device according to claim 5,
wherein the prescribed condition includes a case where the lateral slope influence degree is equal to or greater than a second threshold, the longitudinal slope influence degree is equal to or greater than a sixth threshold, and a value obtained by adding the longitudinal slope influence degree and the lateral slope influence degree is less than a fourth threshold.

14. The determination device according to claim 5,
wherein the prescribed condition is a case where the height information and the curve degree information are greater than a prescribed value, and
the determiner is configured to predict that the first marking line is likely to deviate in both directions of one side and the other side in the movement path width direction when the prescribed condition is satisfied.

15. The determination device according to claim 5,
wherein the prescribed condition is a case where the lateral slope influence degree is greater than a first threshold greater than 0 and the longitudinal slope influence degree is less than a sixth threshold smaller than 0, and
the determiner is configured to predict that the first marking line is likely to deviate in both directions of one side and the other side in the movement path width direction when the prescribed condition is satisfied.

16. The determination device according to claim 5,
wherein the prescribed condition is a case where the lateral slope influence degree is less than a second threshold smaller than 0 and the longitudinal slope influence degree is greater than a fifth threshold greater than 0, and
the determiner is configured to predict that the first marking line is likely to deviate in both directions of one side and the other side in the movement path width direction when the prescribed condition is satisfied.

17. A determination method comprising:
by a computer,
recognizing a surrounding situation including a first marking line for defining a movement path along which a mobile object is moving, on the basis of an output of a detection device that detects a surrounding situation of the mobile object;
recognizing a second marking line for defining a movement path around the mobile object from map information on the basis of positional information of the mobile object; and
determining whether the first marking line and the second marking line deviate from each other,
wherein the map information includes height information and curve degree information of the movement path, and
when the height information and the curve degree information satisfy a prescribed condition, determination that the first marking line and the second marking line deviate from each other is prevented.

18. A computer-readable non-transitory storage medium storing a program for causing a computer to:
recognize a surrounding situation including a first marking line for defining a movement path along which a mobile object is moving, on the basis of an output of a detection device that detects a surrounding situation of the mobile object;
recognize a second marking line for defining a movement path around the mobile object from map information on the basis of positional information of the mobile object; and
determine whether the first marking line and the second marking line deviate from each other,
wherein the map information includes height information and curve degree information of the movement path, and
when the height information and the curve degree information satisfy a prescribed condition, determination that the first marking line and the second marking line deviate from each other is prevented.
